(19) United States
(12) Patent Application Publication
(10) Pub. No.: US 2004/0255289 A1
(43) Pub. Date: Dec. 16, 2004

(54) Remote access software solution for rapidly deploying a desktop

(75) Inventors: Bethlehem Alex George, Calgary (CA); Armstrong Laura Lillian, Calgary (CA)

Correspondence Address: BENNETT JONES LLP, 4500 Bankers Hall East, 855-2nd Street SW, Calgary, AB, T2P 4K7, CA

(73) Assignee: CITYCITES.COM CORP.

(21) Appl. No.: 10/458,743

(22) Filed: Jun. 11, 2003

(51) Int. Cl. G06F 9/445

(52) U.S. Cl. 717/174

(57) ABSTRACT

The present invention comprises a remote access software solution for rapidly deploying a desktop. The present invention includes a remote software application that functions through a client system, a server and a means of communication between the client system and server. A front end and back end coding structure are included programmed into the remote software application. The back end code is installed and functions on the server system and the front end code is installed and functions on the client system. The back end code process user requests and collects desktop specifications and send this information to the front end code by way of the communication means so that a personal desktop environment may be displayed on the client system. The personal desktop environment is deployed according to details of a user's specific user rights and access to specified network resources captured through back end code.

### FIELD OF THE INVENTION

The present invention comprises a remote access software application for rapidly deploying a personalized user desktop environment.

### BACKGROUND INFORMATION

Gone is the time when most workers spent their days in a single location, most often the same location, every day. Today, more and more workers spend their productive working hours in remote locations, on the road, at customer sites, or in home offices. Connecting to corporate intranets through the Internet has become a common practice and workers now “live and breathe” according to their ability to regularly access e-mail, files, calendars, databases, applications, and other shared resources. As the remote workforce increases, so too does the demand for organizations to provide remote access capabilities to these workers including mobile access solutions.

The worldwide remote access market includes multiple hardware and software solutions, collectively referred to as ‘remote access solutions’. Each solution provides a unique delivery and is continually advancing and morphing to adapt to meet the growing demands of this remote mobile workforce.

With these growing demands, remote access has moved up the list of priorities for many network managers. As a result, enterprises of all sizes are looking to new technologies to unite their network computing resources into an easy to use workspace that extends corporate resources in and out of the workplace.

Needless to say, the pressures on administrators to provide workers with access to corporate applications and data, while at the same time ensuring security, high performance and efficient support, all within a limited budget, has escalated. Given this dilemma, companies must find solutions that ensure utmost security with maximum functionality while limiting total cost of ownership.

Adopting an access portal as a centralized location for the aggregation and personalization of information and applications has been one approach advanced to overcome this hurdle. Access portals address a wide range of business issues, in particular, secure delivery of the right information and applications to the right people to aid in the performance of daily business activities. Most of today's enterprise information portals are intended to serve large and often widely distributed organizations. They can take many months to implement, are costly in terms of purchase price and customization, and may contain more features than most businesses actually need. Information included on an information portal is displayed in a prescribed grid specific form.

Another of the available remote access solutions, a virtual private network (VPN) allows enterprises to carve secure and reliable “networks” out of the public Internet infrastructure, and is increasingly becoming a part of every corporation's strategic information technology plan. With an increasing demand for secure corporate data exchange over the Internet, VPNs make the new business landscape more secure and trusted.

However, the very nature of a remote access VPN, being to provide secure access to distributed users at numerous remote locations, introduces a new set of deployment and maintenance concerns that threaten to undermine the potential savings promised by VPN implementations. VPNs are unable to deliver instant and continuous connectivity and are processor-intensive and bandwidth-heavy in use. Another drawback of VPNs is that a VPN client must be installed and maintained on every PC that requires access and each individual PC user must be trained to operate the VPN application. This configuration leads to source data, which often resides on laptop PCs or other devices, being left vulnerable to loss or theft. Once connected via a VPN the remote PC is granted full rights and privileges to roam the corporate network, which may be exploited by hackers using a remote VPN connection to gain access to corporate network resources.

In general, existing remote access solutions function so that, in order to allow applications to run locally on a client machine, while accessing the data from across the Internet seamlessly, a system must physically copy the file onto the local hard drive, and then have the local application use it from there. The problem resulting from this method is that the user sees the application being loaded/saved from an unusual path, one that has no bearing or resemblance to the one where the data originated from. Additionally, if the application requires other files which are not copied across (such as dot files for Microsoft Word templates), these are not implicitly available to the application, and additional care must be taken to provide for applications that rely on that. Each individual application would be a one-off procedure for handling this functionality.

To be truly useful to an organization, the remote workplace needs to be both virtual and accessible from a variety of locales. A remote access solution should display content specific to the user in a manner similar to the desktop the user is accustomed to viewing in their physical workplace, such as an iconic representation as presented by the Windows™ desktop. Furthermore IT administrators must be able to quickly deploy critical network resources in a secure environment while leveraging current investments in existing systems and applications.

### SUMMARY OF THE INVENTION

The invention comprises a method of applying a remote access software solution for rapidly deploying a personalized user desktop environment comprising: a client system; a server system; a remote access software application having a front end and a back end coding structure, whereby the front end coding structure is stored on and functions from the client system while the back end coding structure is stored on and functions from the server system; and a means of communication between the front end and back end coding structures and thereby between the client system and the server system. The communication means between the client and server can be achieved by a variety of means including: Internet/Intranet/Extranet connection; dial-up connection; VPN connection; wireless connection; DSL/high speed connection; or any other network connection.

The back end coding structure of the invention facilitates a compilation of desktop environment related information specific to a user from the server. When the user accesses the server via a client system and a communication means, the back end coding structure collects the applicable information necessary to display a desktop environment virtually the same as the desktop environment that the user can access at a terminal directly connected to the server. The back end coding structure then passes this information to the front end coding structure. The front end coding structure interprets the desktop information received from the server via the back end coding structure, and displays it on the client system as a desktop environment. The desktop environment deployed by the client system is in virtually the same format as the desktop environment normally displayed by the user terminal linked directly to the server, according to the user access rights stored on the server system.

The invention enables a user to access virtually the same desktop environment through a remote client system as is accessible from a terminal directly connected to the server. This provides continuity of desktop environments, which simplifies the experience of a user who must access their files, folders, applications and services from a remote location.

The invention may further comprise a remote access software application wherein an Internet connection, a web browser, and a remote secure access connectivity application, such as Citrix MetaFrame™, Tarantella, and Microsoft Terminal Services are utilized to effect the communication means between the client system and the server system. In one embodiment the invention, functioning through a client system, utilizes at least one applet in conjunction with at least one plug-in. In the circumstance that the client system is connected to the Internet via a web browser, the plug-in may be locally installed within the web browser.

The applet sends and receives client-server requests via a servlet. A desktop interface is created from the information compiled by the back end code. The back end code itself captures graphics and information, including icons, placement, size and captions, from the server for inclusion in the desktop environment. The desktop environment is created by the front-end code. A means for collecting and storing relevant business desktop related information may be coded into the remote software application. Alternatively, a process to collect the relevant desktop related information may be initiated each time the remote software application is launched. In one embodiment of the invention, the desktop interface data is stored inside a hidden file located within the user's home folder and profile on the server system. The user's home profile containing a hidden file is dynamically created by the remote access software application before the desktop environment is downloaded from the server.

The front-end code may also be programmed to collect details regarding files, folders, applications and services contained within the client system so that they can be captured and incorporated into the desktop environment. In one embodiment of the invention, in the circumstance that an application is available remotely from the server system and locally from the client system, the application accessible from the client system will be represented by default on the desktop environment. The desktop interface will dictate all aspects of the desktop environment when it is displayed by the client system, including the appearance of the information, icons, colour, style, shape, look and feel of the desktop environment displayed on the client system. In one embodiment of the invention, special markings may be integrated into the icons that represent files, folders and applications accessed remotely.

Access to a server system can be limited by the remote software application. Generally access limitations will be effected through the co-operation of the software and the server system. The remote access software application may function so that only certain information or specific areas of the server system may be accessed by the remote software application. Alternatively, access to a server system may be blocked altogether upon the occurrence of defined events.

The server is accessed by way of a personal ID and a password using industry standard authentication protocols, such as Microsoft Active Directory (AD), Novell Directory services, or any other authentication protocol. The personal ID and password provide server access according to specific user rights and specified access to network resources. Precise details regarding such user rights and network resources are captured and extended by the desktop interface. The desktop interface transfers these details from the server to the front-end code and displays them as a desktop environment on the client system.

Access to the back end coding structure can be limited by the remote access software application. In one embodiment of the invention, the remote software application is sold to the owner of a server by license so that a limited number of licenses will be available. In one embodiment of the invention a license key pair will be applied by the remote access software application and the back end code will monitor the use of the available licenses. In the situation that all of the available licenses are in use the remote software application will alert the user that there are no available licenses and will fail to authenticate a user to create the desktop environment.

Generally, the invention provides a secure remote access software solution for rapidly deploying a personal desktop environment. Thereby the invention enables a user to connect to a client-server environment from virtually any computer and virtually any network and through such connection to access user-specific networked files, folders, shared folders, applications and services. This access to user-specified networked files, folders, shared folders, applications and services is provided by way of a personal graphical user interface (“GUI”) desktop environment.

The utilization of a back end coding structure allows for an accurate representation of a user's personal desktop environment to be quickly captured and downloaded to the client system. The recreation of a user's personal desktop environment increases a user's productivity by eliminating any need to hunt for image objects pointing to files, folders, applications or services required by the user as files, folders, applications and services will be displayed on the local client system in a manner that virtually mirrors the display on the user's desktop directly connected to the server.

A further aspect of the invention is that it provides a desktop environment that is seamless in its appearance to a user. This is achieved through the integration of the front end and back end coding structures. The benefit achieved is that a user is provided with a smooth application that resembles the application achieved through direct link to the server.

Another aspect of the invention is that it provides a method of allowing applications to run locally on a client machine, while accessing data remotely. This method of virtual drive mapping is performed in a seamless manner and the user does not see the application being loaded or saved from an unusual path which has no bearing or resemblance to the one from where the data originated. The virtual drive mapping component also allows other files that do not exist on the local client and are not copied from their remote location to be available to the application, such as files that support functionality of the application. The benefit is that the remote data accessed is synchronized with the local data and the application is not limited by reliance on solely local files.

These and other features and advantages of the remote access software solution for deploying personalized user desktops according to the present invention will become more apparent with reference to the following detailed description and drawings.

### BRIEF DESCRIPTION OF THE DRAWINGS

FIG. 1 is a flowchart of the program flow for a preferred embodiment of the invention;

FIG. 2 is a flowchart of the program flow of the login process;

FIG. 3 is a flowchart of the program flow of the explorer launch;

FIG. 4 is a schematic diagram of the interaction between the client system and the server during the login routine;

FIG. 5 is a flowchart of the program flow of the license manager;

FIG. 6 is a schematic diagram of the interaction between the client system and the server as required by the license manager;

FIG. 7 is a flowchart of the program flow of the process for retrieving and displaying remote applications and/or portal server icons;

FIG. 8 is a schematic diagram of the interaction between the remote client system and the server for the retrieval and display of remote icons;

FIG. 9 is a flowchart of the program flow of the process for retrieving and displaying local icons;

FIG. 10 is a schematic diagram of the relationship between the remote client system and the server for the retrieval and display of local icons;

FIG. 11 is a flow chart of the interaction between the remote client system and the access to user specific shared folders on the server;

FIG. 12 is a flowchart of the program flow of the file systems operations;

FIG. 12a is a flowchart of the program flow of the cut, copy and paste file system functions;

FIG. 12b is a flowchart of the program flow of the create folder system function;

FIG. 12c is a flowchart of the program flow of the delete folder/file system function;

FIG. 12d is a flowchart of the program flow of the rename folder/file system function;

FIG. 13 is a flowchart of the program flow of the seamless integration of the application with remote elements;

FIG. 14 is a schematic diagram of the interaction between the remote client system and the server to accomplish seamless integration of the application with remote elements;

FIG. 15 is a flow chart of the interaction between the remote client system, server, and seamless integration launching local client and server system applications;

FIG. 16 is a flow chart of the interaction between the remote client system, server, and seamless integration launching web applications from the remote access software application;

FIG. 17 is a flow chart of the interaction between the remote client system and the server to auto refresh the remote access software application dynamically;

FIG. 18 is a schematic diagram of virtual drive mapping; and

FIG. 19 is a flow chart of the log out process of the remote access software application.

### DETAILED DESCRIPTION OF THE PREFERRED EMBODIMENT

The illustrations and examples discussed in the following description are provided for the purpose of describing embodiments of the invention and are not intended to limit the invention thereto.

The remote access software application of the present invention generally comprises a method of communication between a client system and a server whereby information required to display a user's desktop environment is sent from the server to the client system.

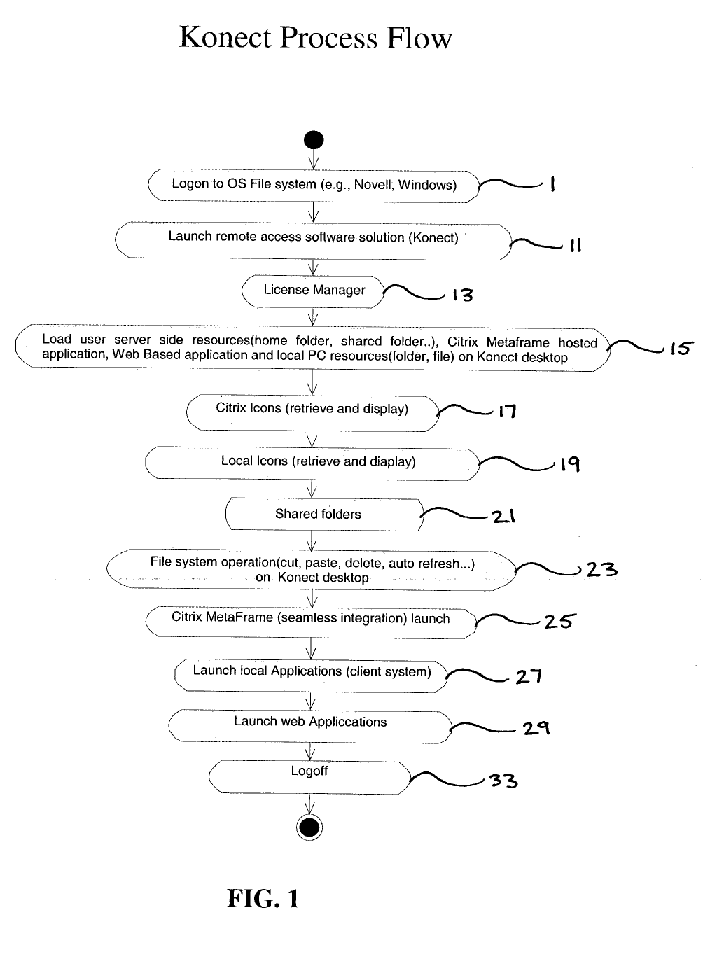

Referring now to FIG. 1, a remote access software application for rapidly deploying a personal user desktop according to the present invention performs several functions and is generally initiated by a login routine 1. The functions collectively comprise a process for dynamically creating a user specific desktop, by utilizing a server 3, a client system 5 and means of facilitating communication between the client system and the server so that information may be passed between them, according to the remote access software application of the invention which is divided into a front end code structure loaded onto the client system and a back end code structure loaded onto a server system.

A preferred embodiment of the invention includes several steps. To initiate the method of the invention a user will launch 11 the remote access software application from the client system 5 and will thereby launch the means of communication between the client system and the server. The communication means may be achieved through the application using virtually any method to access a web server and may include the following elements, a web browser, an Internet connection, an Intranet connection, an Extranet connection, a dial-up connection, a VPN connection, a wireless connection, a DSL or high speed connection or another network connection. The user must provide user identification details at the login step 1 to enable the communication means to access the information relevant to the personal desktop environment of the user stored on the server.

The license application may be initiated 13 once the communication means between the client system and the server has been established. The license application functions to monitor the number of users accessing the remote software application back end code or the server and to ensure that there are enough valid licenses available for the software of the invention, before authenticating a user to his personal desktop.

After a communication means is established between the client system and the server the back end code will cause information in the user's home profile regarding the files, folders, applications and services available to the user via the server to be transferred 15 to the client system. In one embodiment of the invention a hidden folder on the server may be used to store data and link files including filename, type, size, last date modified, path, co-ordinate (x, y) and other details. The back end code may use the information in the hidden folder to accurately present and display the icons for the applications and files on the user's personal desktop, according to the data sent from the server to the remote access software application on the client system. In one embodiment of the invention all application file image objects which may include folders, files, or applications retrieved 17 from the server through the remote access connectivity application, such as Citrix MetaFrame™, Microsoft Terminal Services or Tarantella will have a specific marking integrated into the icons representing them on the desktop environment. The integrated marking will indicate that the file is associated with the remote access connectivity application. The user can launch the local client system and the server files transparently from the desktop environment.

The desktop will automatically map the local client system, thereby making folders, files and applications existing on the local hard drive of the client system available. Utilizing the local hard drive of the client system 5, the remote access software of the invention will retrieve and display 19 local icons for the available applications, files and folders on the desktop. The user may seamlessly launch files from both the server and the local client system hard drive from the desktop environment through applications installed on the local client system.

The remote access software application sets 21 the path and attributes of shared folders so that each of the shared folders stored in the server 3 can be displayed on the desktop environment. The attributes of the image file object representing each folder are utilized to create the appropriate icon and the icon is then included on an array list of desktop icons.

From the remote access software application, users can perform 23 most file system operations such as copy, cut, paste, delete and rename from the desktop environment in a manner that is similar to that applied to a local desktop environment connected to the server. This may include right click functionality, pull down menus and explorer menus as are included in standard software applications. Users may access shared folders from the desktop environment and a user may select the logout function to exit the desktop environment.

Any use of the desktop environment, whether it is to launch a file with a remote access connectivity application 25, a local client application 27, or a web based application 29, may occur in a manner that is seamlessly integrated as it appears to the user 25. Either an applet or a plug-in, or both, may be utilized to aid with the seamless integration of remote and local files associated with a local or remote application being launched from the desktop environment displayed on a client system.

To end a desktop session a user may enable 33 a logout process, which will upload modified desktop settings and files to the server as well as delete all temporary files and folders created on the local client system 5 to support the remote access software session.

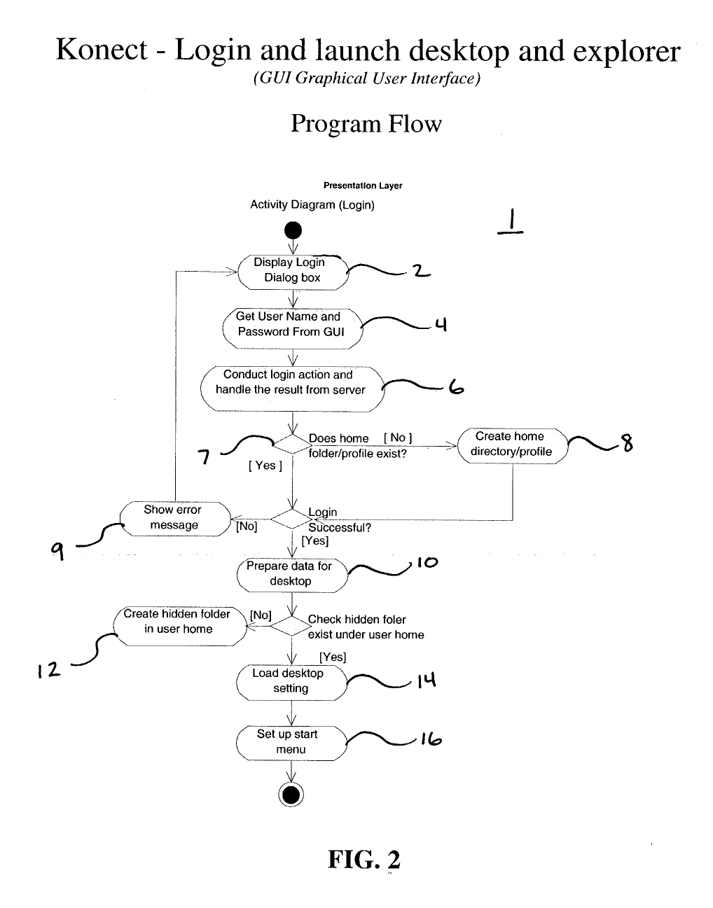

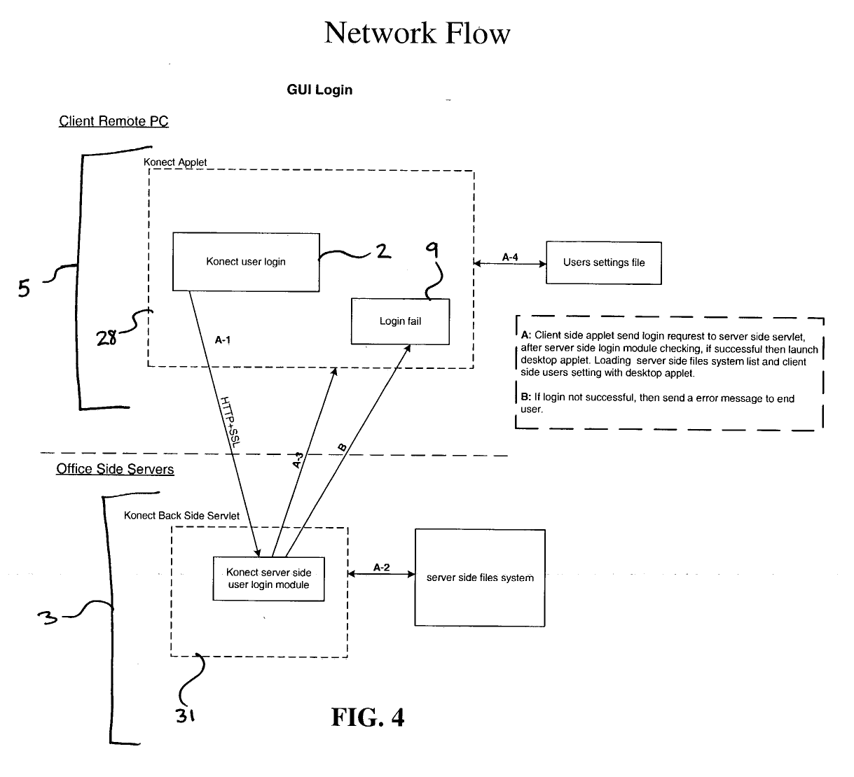

Referring now to FIG. 2 and FIG. 4, in an embodiment of the invention the login routine begins with the display 2 of a dialog box and sent on the client system 5. The user is required to input user ID and password credentials in the appropriate fields on the dialog box by way of an external input means interfaced with the client system 5, such as a standard keyboard. A datastring of login information, containing the user ID and password credentials, is collected 4 from the GUI. The datastring is created and may be encrypted when the user information is inputted into the dialog box and sent to the server to authenticate the credentials of the user. The datastring is utilized to conduct 6 the login routine and to handle and verify 6 the results from the server side user login module that indicate 7 whether a user exists on the server 3. In the instance that a user does not exist on the server an error message is displayed 9 on the client system prompting the user to re-enter a valid user ID and password credentials. If the user exists on the server but the home profile for such user does not exist, the remote access software application will dynamically create 8 a user's home profile on the server 3 in a manner that is transparent to the user. A user's home profile is required to successfully create a personal desktop environment. If the datastring being the user name and password, is authenticated successfully data specific to the user is subsequently retrieved and compiled 10 from the server 3 for a GUI explorer to be utilized to create the desktop environment.

In one embodiment of the invention, a hidden folder must exist within the user's home profile on the server. The hidden folder is necessary for the purpose of storing data and link files on the server. The first time a user logs into his account on the server the remote access software application will determine whether the hidden folder exists on the server 3 within the user's home profile. If a hidden folder does not exist a hidden folder will be created automatically 12 by way of a function performed by the remote access software in a manner that is transparent to a user. The hidden folder will also be created automatically 12 if a hidden folder created for a user during a previous session cannot be located. If the hidden folder exists, icon image objects indicating explicit links to user specific applications, services and files accessible from both the server and the local client system are loaded 14 into a desktop environment via the server back end servlet 31. The desktop environment uses the hidden folder to accurately reflect and position icon image object links on the desktop environment. The desktop environment start menu is automatically populated 16 with user specific item objects while loading the desktop settings.

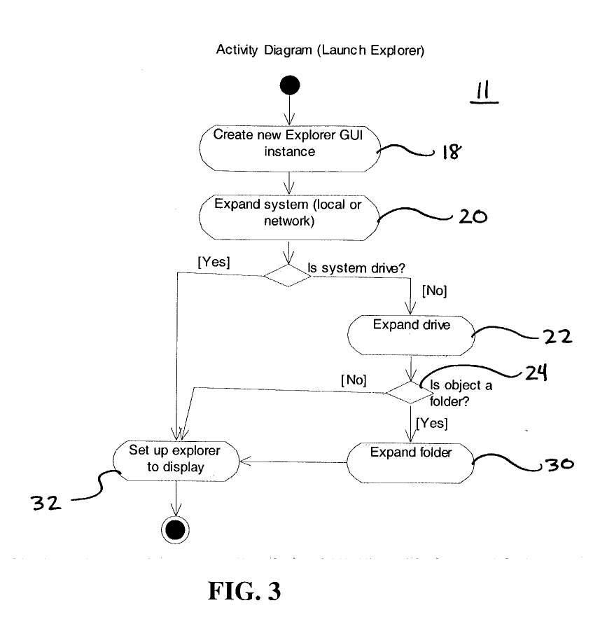

Once the login routine has successfully completed, data for a desktop is prepared 10 and a personal user desktop GUI applet 28 is launched. From the desktop a GUI explorer window can be launched, and expanded as required as shown in FIG. 3. The explorer provides access to both the local client system and network system. An explorer GUI instance expanding both the local and network system drive can be launched 18 by a variety of methods including double clicking on a desktop folder; right clicking to select explorer; or selecting a pull down to select explorer. If the user expands 20 either or both the local or network system drive from the desktop, the GUI explorer will set-up the explorer to present the icon image objects file under the selected drive. If the user expands the local or network system drive and the selected drive has an object under it, the desktop will expand 22 the drive. The remote access software will determine 24 whether the object is a folder, and if so the folder will expand 30 and set-up the explorer to display 32 the item image object within the folder. Otherwise, if the object is not a folder, the icon image object will be assessed and the explorer will be set-up to display 32 the icon image object under the drive.

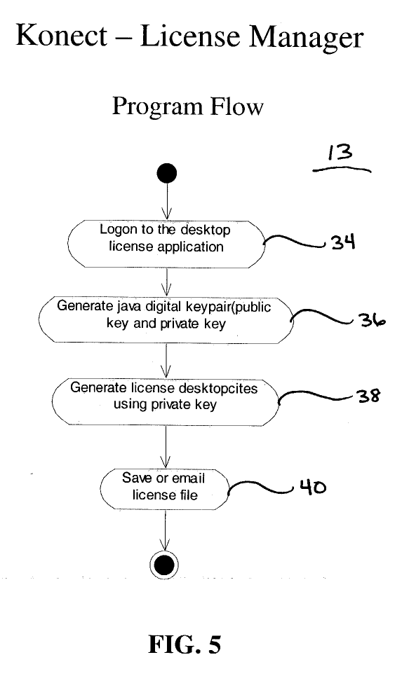

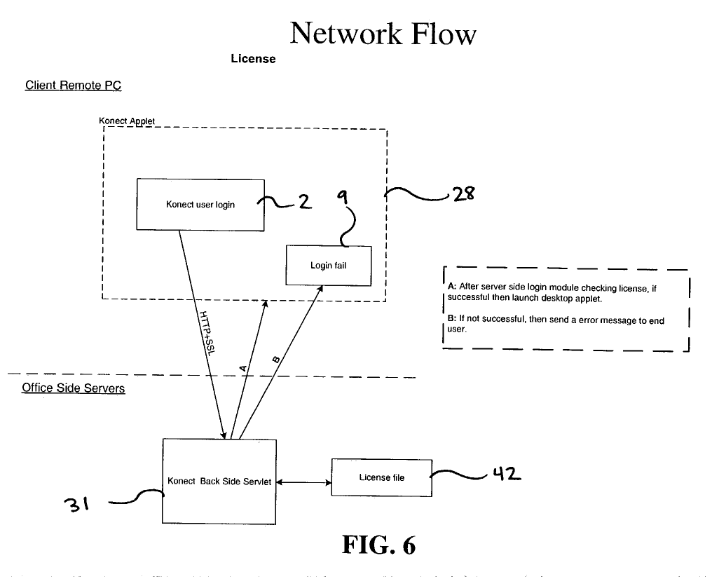

Referring now to FIG. 5 and FIG. 6, a license manager routine 13 will confirm that a valid license for the remote access software is available for the user who is attempting to login, to access their profile on the server. A user will be unable to continue to utilize the remote access software if a valid license is not available.

The license manager routine 34 generates a digital key pair 36. In one embodiment of the invention the digital key pair may be generated in java. A public digital key and a private digital key are generated. The private digital key is used to create 38 a license key for the purpose of allowing a set number of users to concurrently login to the desktop through a network server. The license key and public key may be emailed 40 in a file to the customer to be installed on the network server. Once installed on the server, each user will invoke the license key using their user id and password which transparently compares itself to the public key using the back end servlet 31 which verifies the number of existing valid licenses available and will only authenticate a user and launch a desktop applet 28 if a valid license 42 is available. In the circumstance that a license is unavailable an error message will be displayed on the client system.

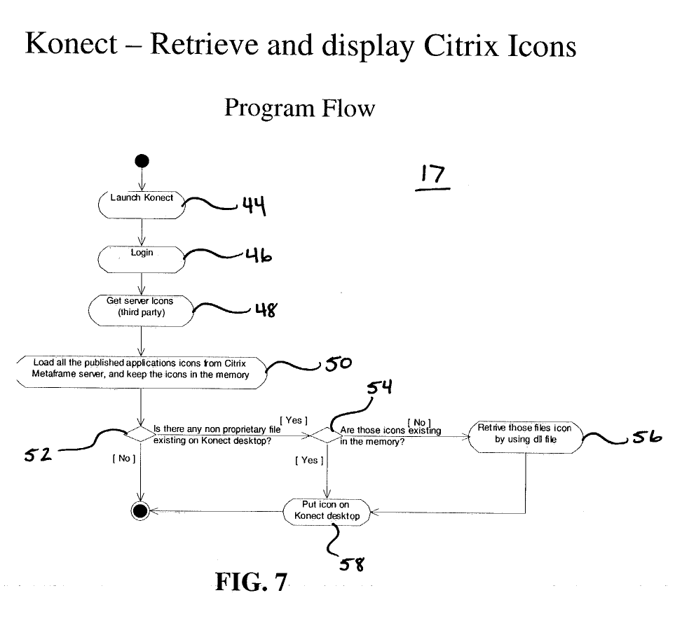

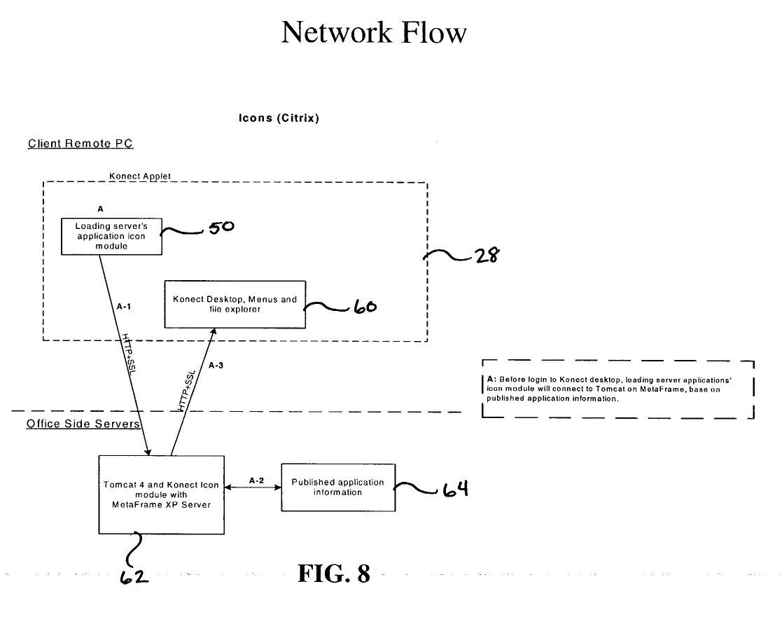

A routine for retrieving and displaying 17 icons accessed remotely is shown in FIG. 7 and FIG. 8. Once launched 44, a remote connectivity software application, such as Citrix MetaFrame™, Tarantella, or Microsoft Terminal Services, installs published applications on the server and has the associated icon image objects to the application and their related extensions in the server PC registry similar to the client local PC registry.

A login dialog box is displayed 46 on the client system for the purpose of authenticating the user. The user authenticates to the server using standard authentication protocols such as Microsoft Active Directory, Novell Directory Services, or Sun One.

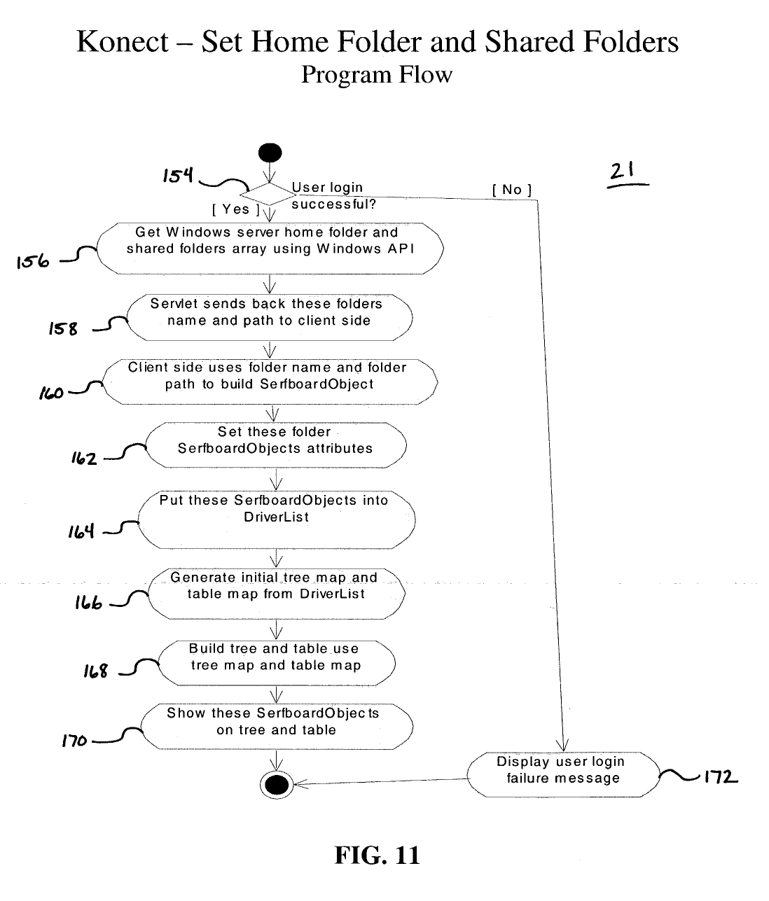

In one embodiment of the invention, when the user successfully authenticates the desktop data to be gathered on the server 3, a servlet 31 is invoked that calls the remote connectivity software application and retrieves 50 user specific published applications 64, extensions, and rights from the server. A file, such as an IconLib.dll, then retrieves 48 the associated icons from the local registry on the server in relation to the retrieved applications and extensions. As shown in FIG. 11, the local PC registry on the server contains all the relative information about the file extension and related applications and icons to those extensions. These retrieved icon image objects and their related extensions with user specific published applications and rights are then sent in an input stream from the server and are loaded 50 to the client system and are stored in a table, preferably a hash table, in the client system memory. The remote access software determines 52 whether there are any non-proprietary image objects on the local client system. Proprietary image objects that are inherent to the desktop of the invention, including buttons, icons, images and other graphical representations are loaded 58 on the desktop as icon image objects. If the image objects on the desktop are non-proprietary image objects, the remote access software may perform a check to find icon image objects existing 54 within the hash table in the client system memory. If the image icon files exist in the client system memory, it may be caused to appear 58 on the desktop to accurately reflect the desktop object on demand in real time. If no image icon object is found in the client system memory, a local client system search that invokes a file, such as IconLib.dll, to retrieve 56 local icon image objects may be utilized. If the image icon object exists on the local client system, it is then used to accurately reflect the desktop object on demand in real time.

In one embodiment of the invention, the image icon objects from the server may be tagged with a unique smaller second image icon object integrated into the standard desktop icon image object representation to help a user distinguish between server and local files and applications being launched from the desktop environment of the invention.

The desktop 28 is seamlessly populated with user specific applications that appear within a pull down menu 60 that is specific to an individual user.

An imagemanager 62 may be utilized to accurately represent and reflect the proper icon image file object 64 for the associated files, folders or applications on the desktop environment.

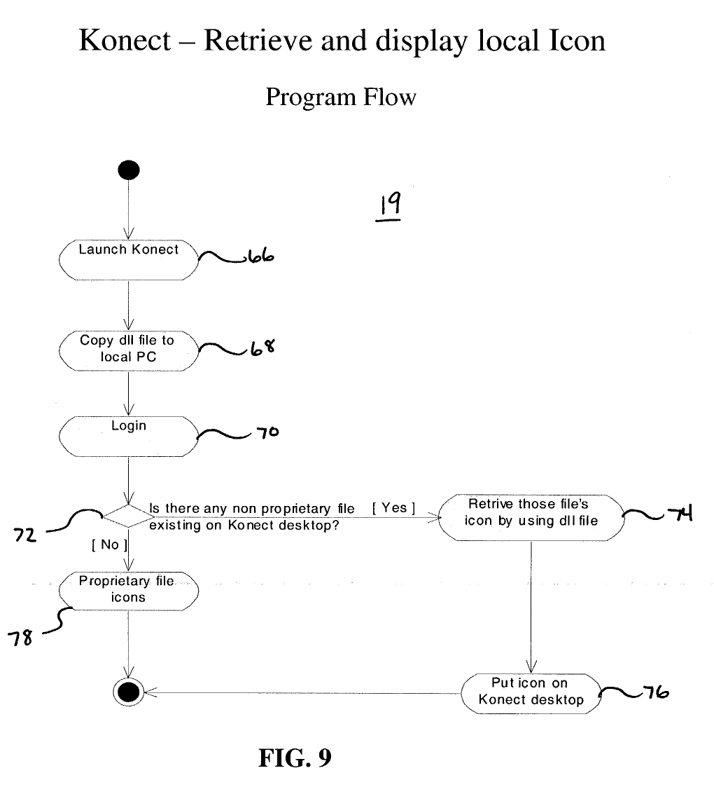

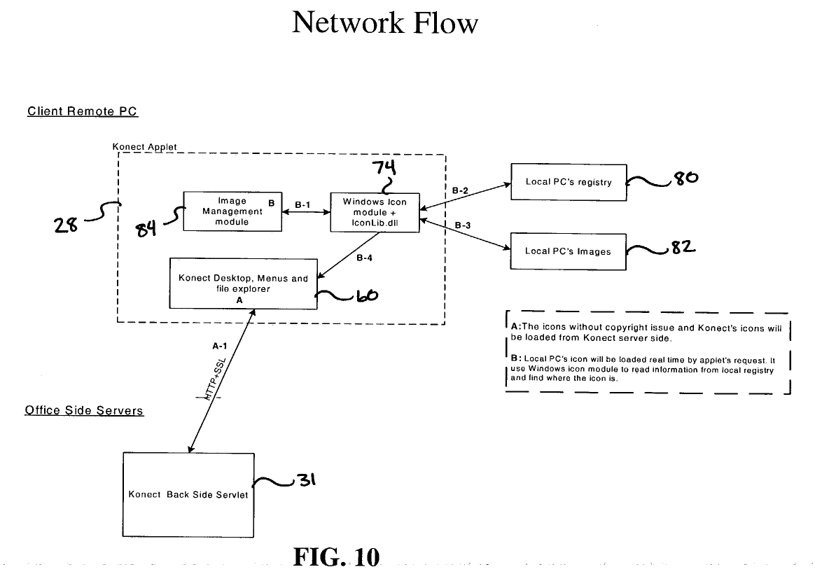

Icons from the client system are retrieved and displayed 19 in a similar manner, as shown in FIG. 9 and FIG. 10, to the retrieval and display routine applied to items accessed through the remote access software application. The desktop must be launched 66 which causes a jar file, and at least one dll file to be downloaded to the client system. Preferably, a frontend jar file, an IconLib.dll file and a Winexe.dll file are utilized. The dll file may be copied 68 to the client system. In the preferred embodiment, a java path file, such as library path, sets the copied dll file.

A login dialog box is displayed to authenticate 70 the user. Once authenticated, the desktop handles both proprietary and non-proprietary icons image objects to accurately reflect the desktop environment. After the remote access software determines 72 whether any non-proprietary image objects exist on the desktop, the proprietary icon image objects inherent to the desktop, are downloaded from the server in real time on demand and are stored in the memory of the client system. These proprietary icons are used to present 78 icon buttons and file images on the desktop. If the icon image objects on the desktop are non-proprietary, the dll file is used to dynamically retrieve 74 local non-proprietary icon PC image objects 82 from the local PC registry 80 relative to their extensions. Non-proprietary icon image objects, which are not inherent to the desktop, that are obtained from the client system on demand in real time. The imagemanager 84 is utilized to accurately retrieve and display 76 the local PC icon image objects associated to files, folders or applications on the desktop environment.

In one embodiment the icon image objects presented on the desktop are generated by retrieving both a home profile file list (Physical files) of a user and a hidden folder file list (Link files). These two lists are then compared to ensure that each Physical file has an associated Link file which is necessary for the desktop to accurately reflect each icon image object. When an action is invoked on the desktop level, a comparison between the user's home profile file list and the hidden folder file list is made to ensure that each icon image object on the desktop has a corresponding link file in the hidden folder to accurately reflect the desktop environment. The icon image object is then presented on the desktop with the correct icon to accurately reflect each icon image object.

Retrieving the home profile file list of the user from the server generates the icon image objects presented in the desktop explorer tree. The desktop then uses this file list to build an icon image object for each item within this list. The icon image object is then presented in the desktop explorer tree with the correct icon image to accurately reflect each image object.

Referring now to FIG. 11 a process for setting the folder path attributes and string is shown 21. This process may only occur if a user successfully completes the login routine 154. If the login is not successfully completed an error message indicating that the login failed will be displayed 172. When the remote access software is installed on the server, the administrator will be prompted to set the remote application software home folder path to a location of their choice on the server. If the login by the user to the file server is successful, the remote access software application on the server side will use a servlet 31 to locate 156 the user home profile folder and any associated shared folders. The home profile folder path attribute and the name and path string of any shared folders which are defined by an administrator using industry standard management tools on the server, such as Active Directory or Novell Directory Services, will then be set which will be used to define each user's home profile path. This information may be attached to the login successful string and will be sent 158 to the client system via the server servlet 31 as part of the login successful string when the string is sent to the client system.

Utilizing the information contained in the string, an icon image object may be created 160 for each of the home profile folder and shared folders image objects on the desktop. The attributes of the icon image object will be set 162 and each icon will be included 164 on an array list, preferably the Driver Array List. A tree and table map may be built 166 from the array list. A JTree and JTable will be generated 168 using the tree and table map. JTree and JTable may then be moved 170 into a JPanel of the explorer. The JTree is used to present image objects within the JPanel of the explorer desktop. The JTable is used to map and correspond the image objects with the right attributes presented in the explorer.

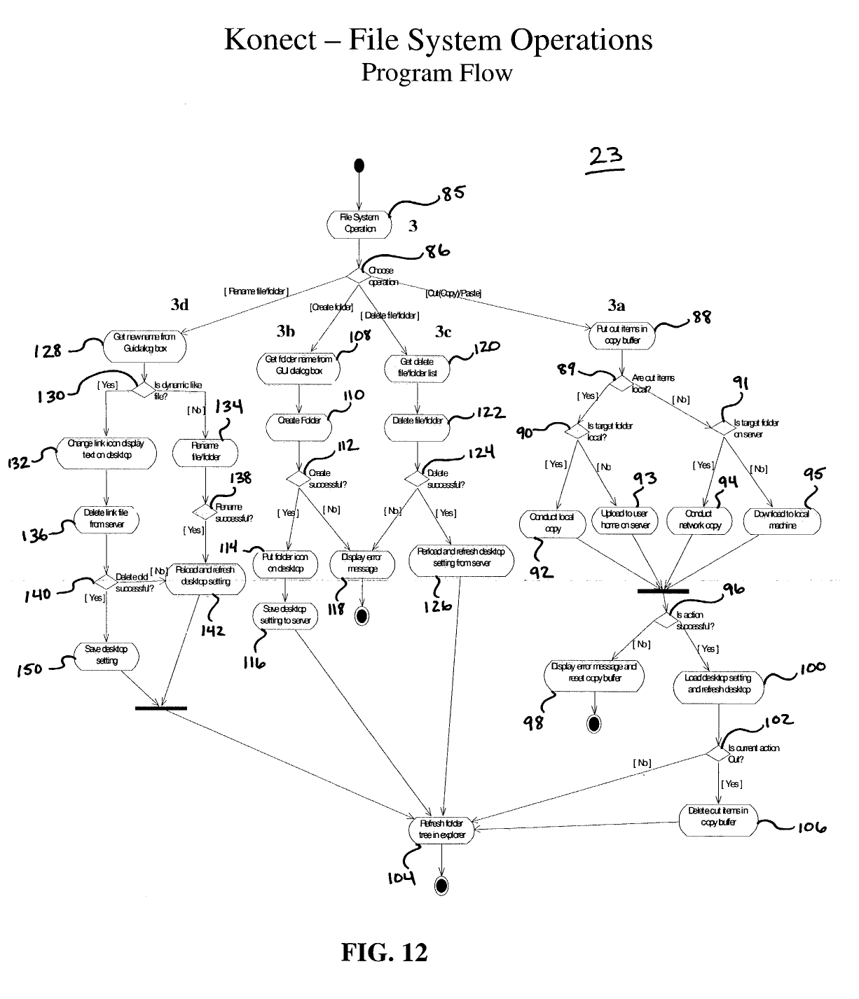

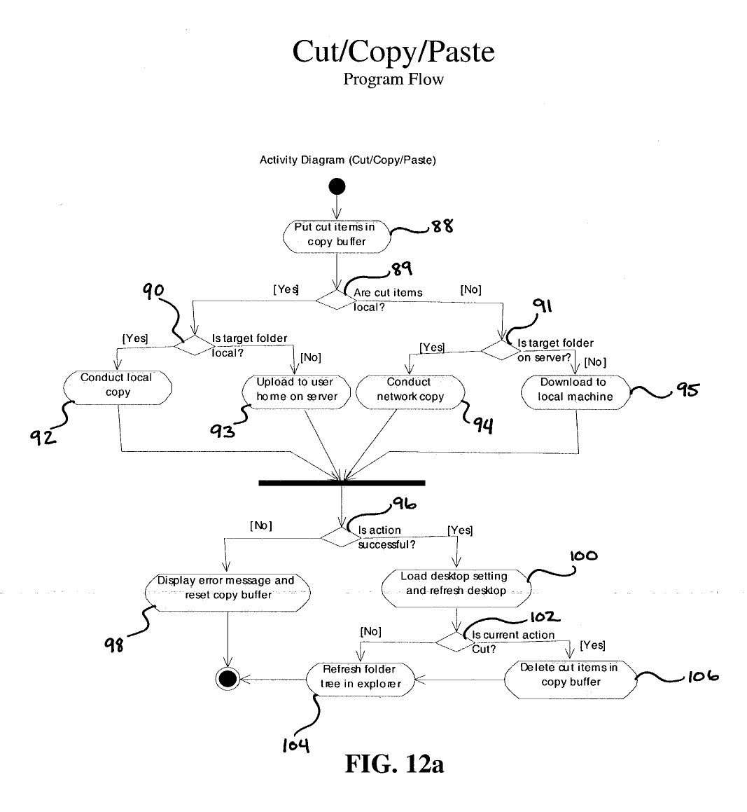

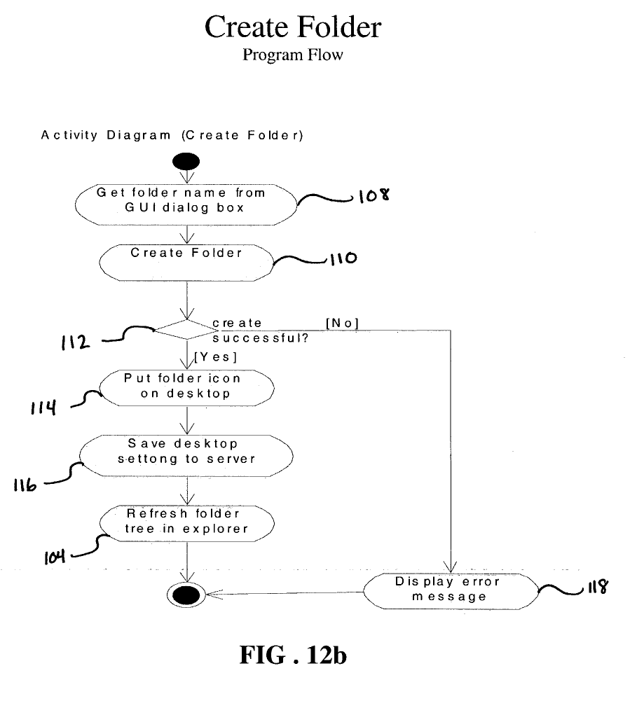

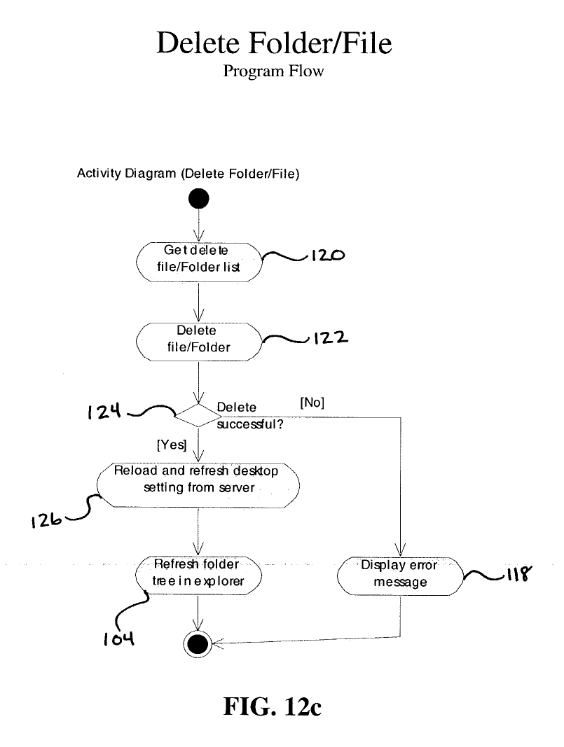

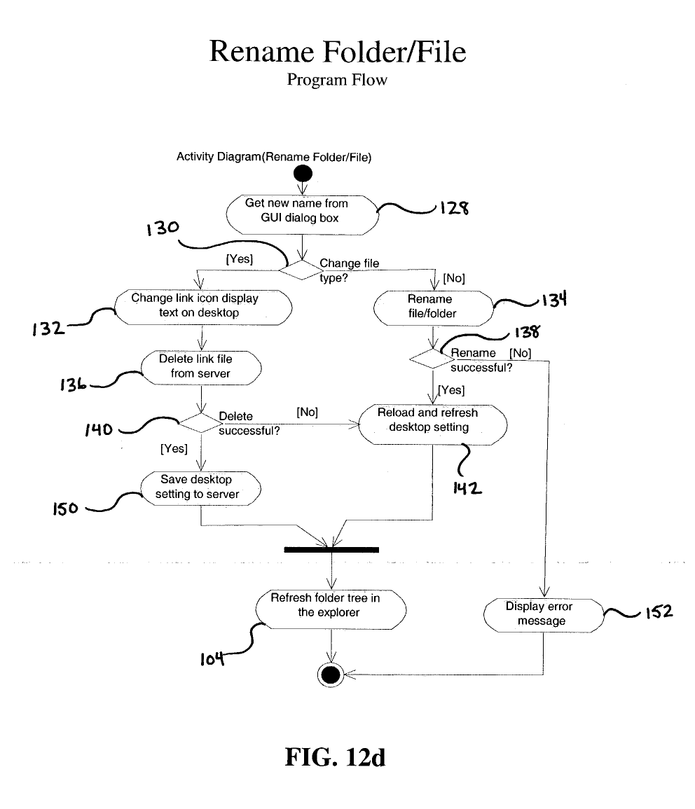

Once a desktop is created a full range of file system operations 23 are available, as shown in FIG. 12. Icon image objects such as files, folders and applications included on a user's desktop can be cut, copied, pasted, created, deleted and renamed in a manner that looks and feels to the user identical to the method applied to performing the same function operations in a non-remote environment. The desktop also utilizes an auto refresh, which dynamically refreshes the desktop when a file object is created on the server using the desktop or a non-proprietary application.

The function of cutting, copying or pasting a file or folder is shown in FIG. 12a. In the preferred embodiment of the invention the function of copying, cutting or pasting files or folders is similar in look and feel to that required by other software applications, as perceived by a user, ensuring continuity between the user experience of a desktop retrieved remotely and a non-remote desktop environment. To perform a function, a user can right click on a mouse 85 and select 86 the copy, cut or paste option from a drop-down menu, or enter an equivalent manual command.

Once a file or folder has been stored 88 in the buffer the software will review the location of the selected file or folder 89 and determine if the file of folder exists on the client system. A positive response to this query is followed up by a second query 90 as to whether the target folder is stored on the client system. If this second query 90 is answered in the affirmative the requested function to cut, copy or paste the item stored in the buffer is conducted locally 92, by the client system. If the second query 90 is answered in the negative the selected item will be uploaded to a user's home profile 93 stored on the server 3.

A different set of rules will be applied if the first query 89 determines that the file or folder does not exist on the client system. A second query 91 will ascertain if the file or folder exists on the server 3. A positive response to this second query 91 causes the requested function to cut, copy or paste the item stored in the buffer to be conducted remotely 94 by the server 3. Whereas, a negative response to the second query 91 causes the selected item to be downloaded 95 to the local client system 5.

A test 96 as to whether the preceding actions 92, 93, 94 or 95 completed successfully occurs. An unsuccessful completion results in an error message being displayed on the client system 5 and reset of the buffer 98. A successful completion of cut, copy or paste causes the desktop object to be loaded to the server 3 and the desktop to be refreshed 100. A review is made as to whether the requested function is a cut, copy or paste function 102. If the function is a copy paste function may then refresh the folder tree. If the function is a cut, then delete cut item out of the copy buffer 106 and then refresh the folder tree 104.

Referring now to FIG. 12b, the file system operation of creating a folder is shown. In a preferred embodiment the function of creating a folder is similar in look and feel to that required by other software applications, as perceived by a user, ensuring continuity between the user experience of a desktop retrieved remotely and a non-remote desktop environment. A user can utilize a mouse to select the create option from a drop-down menu, or a user can utilize an equivalent manual command. The name of the folder may be entered into a GUI dialog box 108, although in other embodiments other means of obtaining the name of the folder may be applied.

A folder will be created 110 and this process will be monitored by the system 112 so that if the folder is not created successfully an error message will be displayed 118. Upon the successful creation of a folder an icon image object for the folder will be added 114 to the desktop and the corresponding desktop setting will be saved 116 to the server 3. At this point the desktop and the folder tree in the explorer will be refreshed 104.

The function of deleting a file or folder is shown in FIG. 12c. In a preferred embodiment the function of deleting a folder is similar in look and feel to that required by other software applications, as perceived by a user, ensuring continuity between the user experience of a desktop retrieved remotely and a non-remote desktop environment. A user must first select an object to be deleted and then right click on a mouse 120 and select the delete option from a drop-down menu, or enter an equivalent manual command 122.

It will be determined whether the requested delete function was successful 124. An unsuccessful delete function will cause an error message to be displayed 118 on the client system 5. A successful delete function of an icon image object will be followed by a refresh of the desktop setting and the desktop will be reloaded subsequently from the server 126. The desktop and the folder tree 104 in the explorer will be refreshed immediately thereafter.

The function of renaming a folder or file is shown in FIG. 12d. In a preferred embodiment the function of renaming a folder is similar in look and feel to that required by other software applications, as perceived by a user, ensuring continuity between the user experience of a desktop retrieved remotely and a non-remote desktop environment. A user must first select an object to be renamed and then right click on a mouse and select the rename option from a drop-down menu, or enter an equivalent manual command. The new name to be applied to the file or folder will be entered in a GUI dialog box 128, although in other embodiments other means of obtaining the name of the folder may be applied.

A query response is used to check if the file type is changed. If not, the file or folder will have the new name saved as the name of the file or folder 134 and this rename process will be reviewed in order to ascertain that the rename process completed successfully 138. An unsuccessful completion of the rename process will result in an error message 152 being displayed on the client system 5. Whereas, a successful completion of the rename process will be followed by the desktop setting being reloaded and refreshed 142 and then the folder tree in the explorer being refreshed 104.

If the query response used to check if the file type is changed 130 is yes, the file will have its icon image object display and name link altered on the desktop to reflect the new object link file 132. The old icon image object is then deleted and replaced with a new icon image object from the server 136. If deleting the icon image object is unsuccessful, the desktop will reload and refresh desktop setting 142. A successful deletion 140 causes the desktop setting to be saved 150 to the server 3 and the desktop, and the folder tree in the explorer to be refreshed 104.

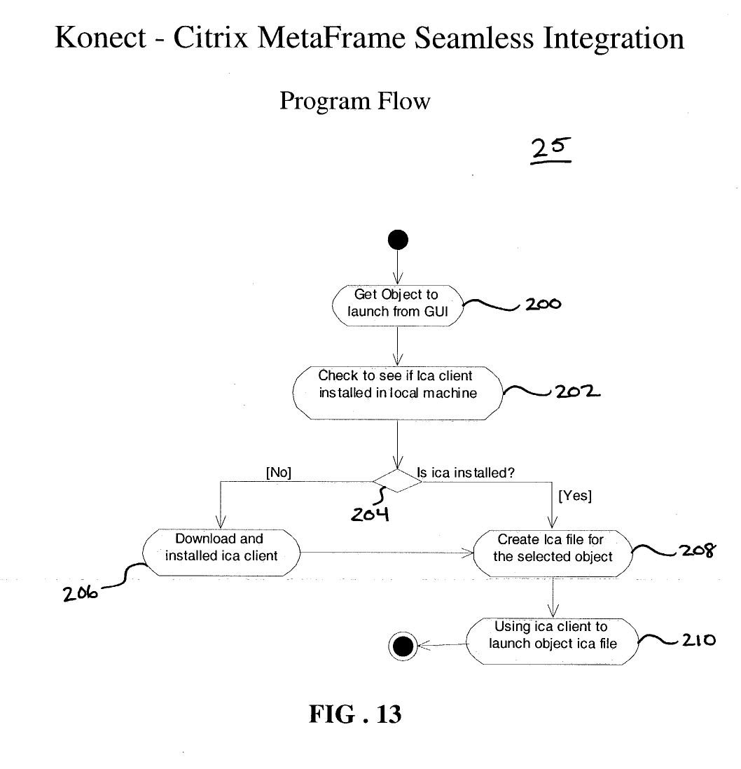

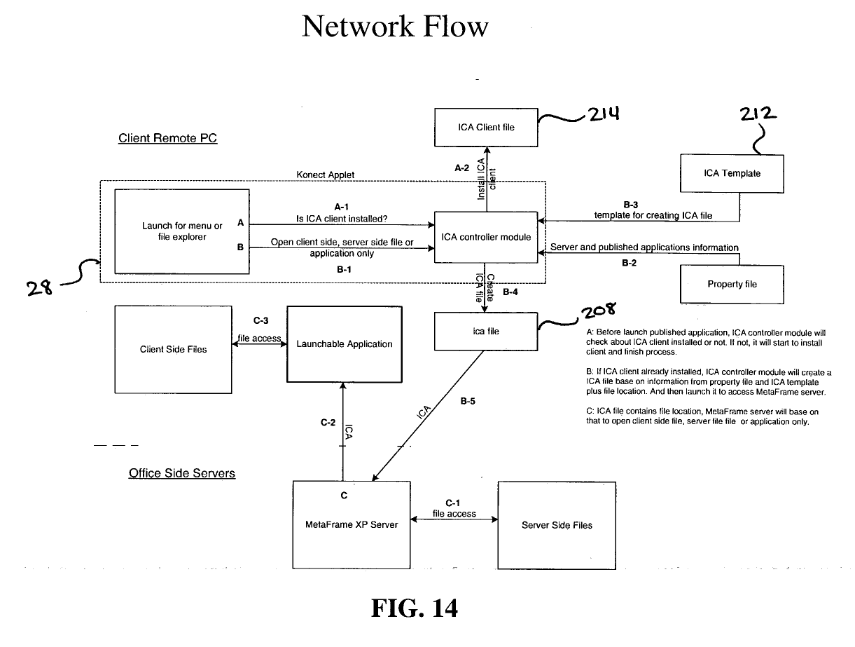

The system is presented in a manner so that a seamless integration with the remote connectivity software, such as Citrix, Tarantella, and Microsoft Terminal Services, is achieved 25, as shown in FIG. 13 and FIG. 14. From the desktop simply double click on the selected icon image object with a mouse, or performing a comparable manual command can launch an application or file associated with an application represented by an icon on the desktop environment. This action will capture the information regarding the image object represented by the icon 200. At this point the system will check whether the required remote secure access connectivity application plug-in (the “ICA client”) necessary to launch the selected icon image object using the remote connectivity software 202 is installed on the client system. The system will then cause two different sets of events to occur depending on the above evaluation 204. If the ICA client is not installed the user will be presented with a walk through plug-in routine that must be completed in order to install the ICA client by way of a download of the necessary files 206. Subsequently, once an ICA client installation routine has been completed, or if the above referenced evaluation 204 finds that the ICA client is already installed, an ICA file 208 will be created dynamically for the selected icon image object on the client system. The creation of the ICA file uses information from: the selected object; the ICA client file 214; the ICA template 212; and the system properties file 208. The generated ICA file will use a remote connectivity application to launch the selected icon image object 210.

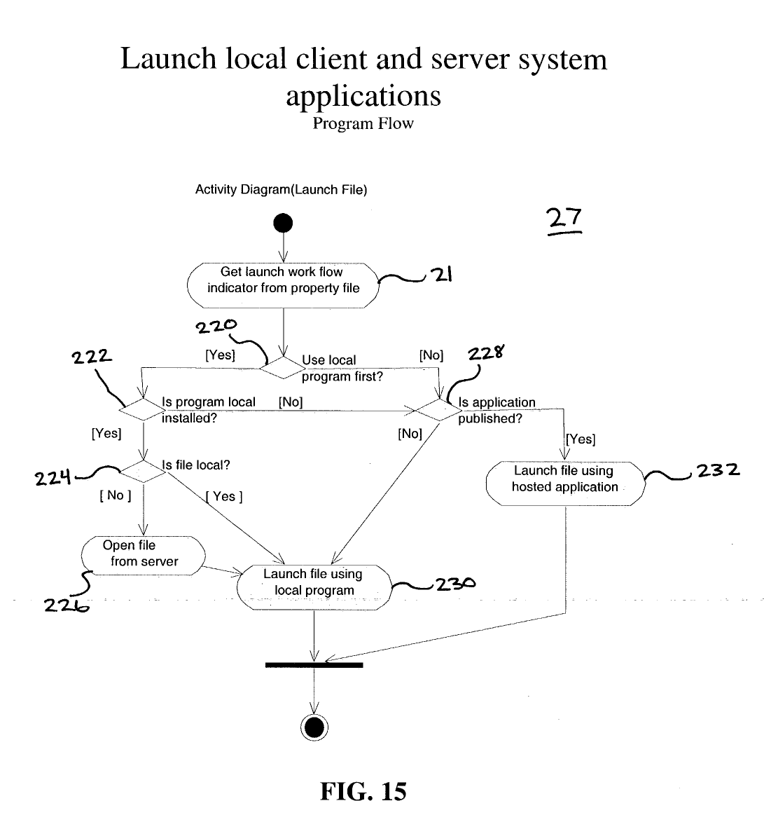

Referring now to FIG. 15 a process for launching a local client and server system application is described. The attributes of the image object icons are captured and utilized to create icon image objects, which are included on the array list. In the occurrence that an application is available on both the local client system and via the server the remote access software application will follow the following steps to determine whether the local application or the application on the server should be launched.

The remote access software application will indicate 220 at a login screen whether there is a preference the user may select so that the local application, as opposed to a server application, will be utilized first. The selection sets the properties file 21 from the server and is transparent to the end user. By default the preference may be set to utilize either local or server applications initially. If the local application is to be utilized first the remote access software application will determine 222 whether the application is installed on the local client system locally. If the application is installed locally, the remote access software application will determine 224 whether the requested file is stored on the local client system. If the file is stored locally the file will be launched 230 using the local application. If the file is not available on the local client, the file will be opened on the server and downloaded 226 to the local client system memory from the server 3 to the local client system using the local application.

In the circumstance that the application on the server will be utilized first, the remote access software application will determine 228 whether the application is published. If the application is not published, the remote access software application will determine whether the same application is available on the local client system and will launch the file using a local application 230, if a local application is available. If the application is not available on the server, or the local client system, the icon will appear with an unknown icon image object. If the application is published the file will be labeled with a unique icon image object label. The file will then be launched 232 using the published application from the server. Files from both the local client and the server labeled with this unique icon image object label will be launched 232 using the application hosted on the server.

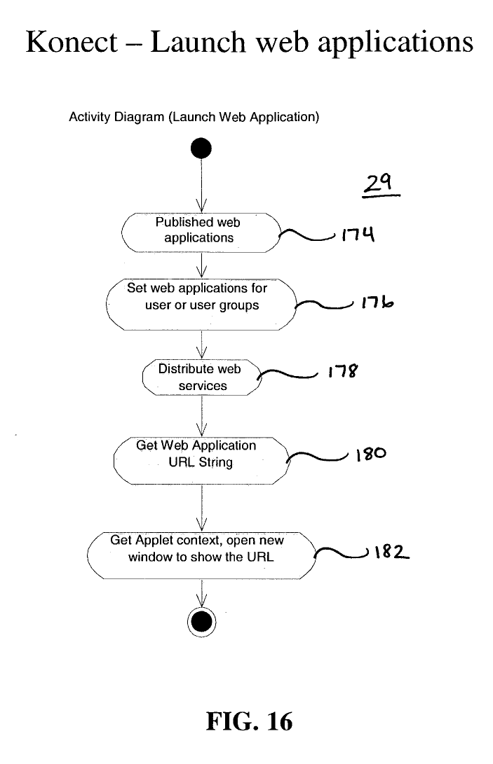

FIG. 16 shows the steps involved in publishing and launching a web application 29. Web applications can be published 174 using the remote access software solution invention. Published web applications can then be set 176 for specific desktop users or user groups to effectively distribute the right web services to the right user. During the login process, the desktop uses the user or user group policies from standard authentication protocols such as Active Directory and Novell Directory Services to distribute 178 published web applications and services. A user may preferably double-click on an icon image object shown on the desktop, or may select the icon through any alternate method, thereby sending 180 a get web application URL string to the server 3. The remote access software application will capture 182 the applet content and open a new web browser window to display the web application.

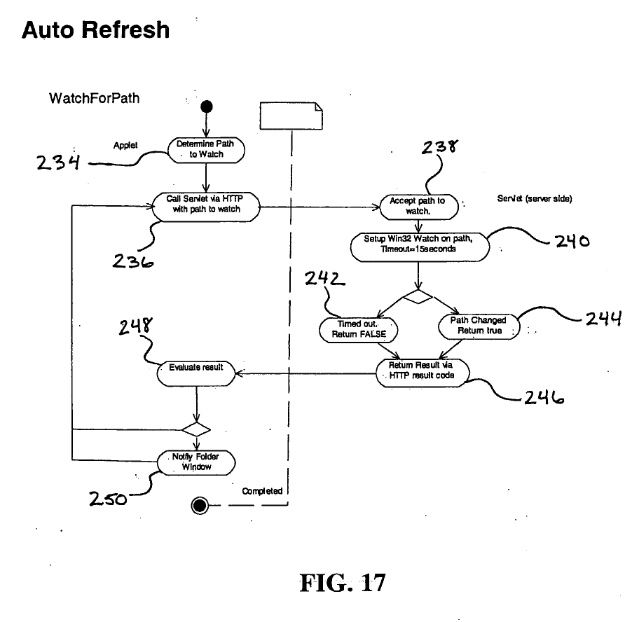

Referring to FIG. 17 the logic flow of the auto refresh module is shown. The application on the local client, where the applet exists, determines 234 the appropriate path that must be monitored on the server. This is the path to the remote data that will be utilized by the local application. Once the path is established the applet establishes a loop which regularly asks 236 the server if the path has changed. The servlet 31 on the server handles 238 the request.

Using an application interface (API) such as the Win32, or Linux APIs the servlet monitors 240 the path for any changes. A timeout deadline may be set. In a preferred embodiment a timeout deadline of 15 seconds will be set, but any amount of time or an event may be set, or alternatively, no timeout deadline need be set. In the circumstance that the API times out a code will be returned 242 to the applet indicating that the path did not change, such as FALSE, but any other code indicator may be utilized. If the servlet 31 perceives that the path has changed prior to the timeout deadline, then no timeout will occur. A code will be returned 244 to the applet indicating that the path did change. The code may be TRUE, but any other code indicator may be utilized. The code will be returned 246 to the applet for evaluation.

The applet will evaluate 248 the code that is sent to it for the purpose of determining the result of the path. In the circumstance that the result is that the path has changed, the applet will notify 250 the remote software application to refresh the desktop and explorer to accurately reflect the icon image objects. This loop will continue to be performed in the mode described until the user desktop is destroyed or closed.

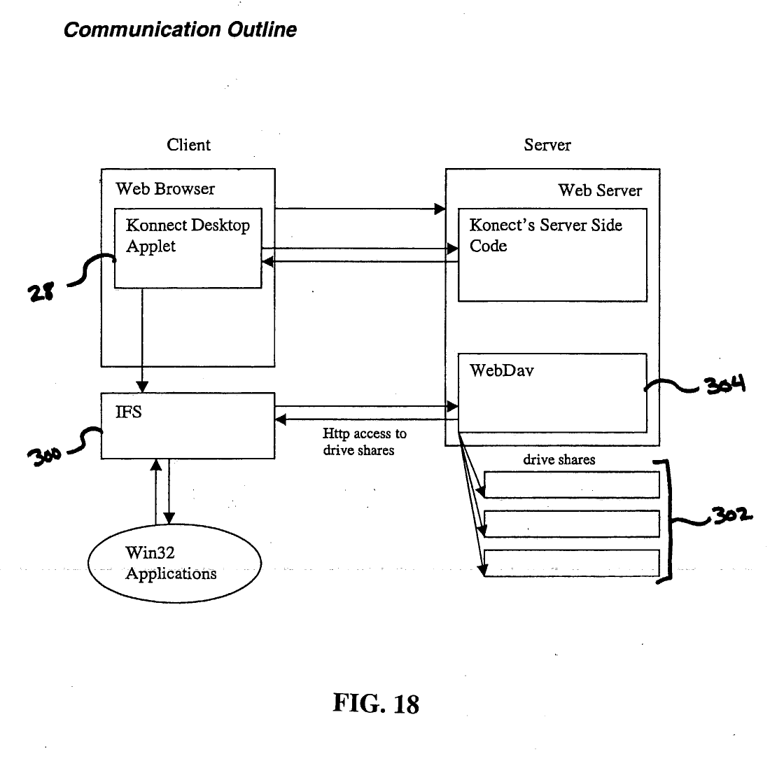

A virtual drive-mapping component, as shown in FIG. 18, enables an application to run locally on the client while data is accessed from a remote site, such as across the Internet. The virtual drive-mapping component monitors for file changes and ensures that there is synchronization between the client 5 and server 3. Files are transparently moved back and forth between the client and the server. To facilitate the virtual drive mapping the remote software application requires an Installable file System (IFS) 300 that communicates at the operating system level to provide the applications with a drive letter that appears to be just like any other locally mapped drive. The applet 28, once granted security access via a signed certificate that accompanies the download, has the authority to install new drivers on the fly that will allow the IFS to map in new drives. The IFS 300 can be constructed to allow multiple paths 302 on the server to be mapped into a single drive letter, building a completely virtual drive.

Using industry standard communications protocols, a WebDav server 304 can be created that allows network administrators to map drive shares into a specially configured web server that provides access to these shares. This provides for standardized security measures to be in place, without the need to build additional modules.

The WebDav component can be hosted from a variety of WebServers including Microsoft's IIS, Apache, and Tomcat.

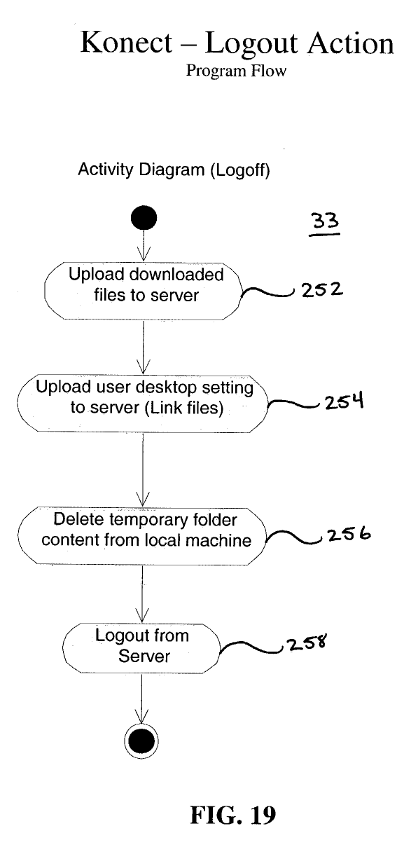

Referring to FIG. 19, a procedure to logout of the remote access software application is shown. Upon the remote access software application receiving a command to logout, any edited data and files that were downloaded to the local client system temporary memory will be saved and uploaded 252 to the server 3. All modified desktop settings will also be uploaded 254 to the server 3. The contents of a local client system temporary folder supporting the remote access software application session will be deleted 256. At this time the remote access software application will logout 258 the user from the server.

Although preferred embodiments of the present invention have been described in some detail hereinabove, those skilled in the art will recognise that various substitutions and modifications may be made to the invention without departing from the scope and spirit of the appended claims.

We claim:

1. A remote access software solution for rapidly deploying a personalized user desktop environment comprising:
a server system;
a client system capable of displaying a desktop environment;
a remote access software application having a front end coding structure and a back end coding structure the front end coding structure being stored on and functioning from the client system and the back end coding structure being stored on and functioning from the server system;
a means of communication between the front end and back end coding structures whereby the client system and the server system may communicate.

2. The remote access desktop software application according to claim 1 wherein the client system incorporates a hard drive.

3. The remote access desktop software application according to claim 1 wherein communication means between the client system and the server system may be effected via the Internet accessed through the web browser and the application of a remote secure access connectivity software application.

4. The remote access desktop software application according to claim 1 wherein the back end coding structure gathers data from the server necessary to replicate a desktop environment and sends the desktop data to the front end coding structure.

5. The remote access desktop software application according to claim 5 wherein the back end coding structure utilizes a string of proprietary data to access the desktop data or the server.

6. The remote access desktop software application according to claim 4 wherein the string of proprietary data includes a user ID and a user password gathered by the front end code and transferred to the back end code by way of the communication means.

7. The remote access desktop software application according to claim 1 wherein a license manager routine confirms that a valid license is available for the remote access software before the back end coding structure transfers data from the server to the client system.

8. The remote access desktop software application according to claim 1 wherein the front end code maps the client system to make image objects links for folders, files and applications existing on the client hard drive available to the desktop environment.

9. The remote access desktop software application according to claim 8 wherein the image object has a non-proprietary icon related to it that is included on an array list of desktop icons.

10. The remote access desktop software application according to claim 1 wherein the integration of the front end code and the back end code functions in a manner that is seamless as perceived by a user.

11. The remote access desktop software application according to claim 1 wherein a virtual drive mapping component enables an application to run locally on a client while data is accessed and stored remotely.

12. A method of applying a remote access software solution for rapidly deploying a personalized user desktop environment comprising:
a server system;
a client system capable of displaying a desktop environment;
a remote access software application having a front end and a back end coding structure being stored on and functioning from the client system and the back end coding structure being stored on and functioning from the server system;
a means of communication between the front end coding structure and the back end coding structure whereby the client system and the server system may communicate;
a means for personalization of a desktop environment to provide a user with access to particular information and applications whereby the data necessary to emulate the personalized desktop environment of a user may be collected by the back end coding structure and transferred via the communication means to the front end coding structure.

13. The remote access desktop software application according to claim 12 wherein the client system incorporates a hard drive.

14. The remote access desktop software application according to claim 12 wherein communication means between the client system and the server system may be effected via the Internet accessed through the web browser and the application of a remote secure access connectivity software application.

15. The remote access desktop software application according to claim 12 wherein the back end coding structure utilizes a string of proprietary data to access the personalized desktop data on the server.

16. The remote access desktop software application according to claim 15 wherein the string of proprietary data includes a user ID and a user password gathered by the front end code and transferred to the back end code by way of the communication means.

17. The remote access desktop software application according to claim 15 wherein the string of proprietary data is created when a user inputs data into a dialog box and the datastring is collected from a graphic interface by the front end coding structure and is transferred to the server via the communication means so that the string of proprietary data can be utilized by the back end coding structure to conduct the login routine and to handle and verify the results from the server side login module to gain access to at least a portion of the server.

18. The remote access desktop software application according to claim 12 wherein the personalized desktop data is stored in a folder on the server.

19. The remote access desktop software application according to claim 18 wherein the folder is created by the back end coding structure.

20. The remote access desktop software application according to claim 12 wherein a graphical user interface applet is launched to provide access to both the local client system and a network system existing on the server.

21. The remote access desktop software application according to claim 20 wherein the graphical user interface applet makes a graphical user interface explorer available to be launched to expand either or both the local or network system drives from the desktop environment.

22. The remote access desktop software application according to claim 12 wherein a license manager routine confirms that a valid license is available for the remote access software before the back end coding structure transfers data from the server to the client system and prohibits a user from the remote access software if a valid license is not available.

23. The remote access desktop software application according to claims 23 and 16 wherein the license manager routine generates a digital key pair, including a private key and a public key, the public key compares itself to the user id and password contained within the string of proprietary information and the public key is emailed to be installed on the network server.

24. The remote access desktop software application according to claim 12 wherein the front end code maps the client system to make image objects links for folders, files and applications existing on the client hard drive available to the desktop environment.

25. The remote access desktop software application according to claim 12 wherein the personalized desktop data is translated to make image objects links for folders, files and applications existing on the server available to the desktop environment.

26. The remote access desktop software application according to claim 25 wherein the image object integrates a specific marking into the image object icon displayed on the desktop environment.

27. The remote access desktop software application according to claims 24 and 25 wherein the image object is produced in a manner that is seamless as perceived by a user.

28. The remote access desktop software application according to claims 24 and 25 wherein the icon may be copied, cut, pasted, deleted and renamed from the desktop environment.

29. The remote access desktop software application according to claims 24 and 25 wherein the image object displays shared folders as an icon on the desktop environment.

30. The remote access desktop software application according to claim 12 wherein the integration of the front end code and the back end code functions in a manner that is seamless as perceived by a user.

31. The remote access desktop software application according to claim 12 wherein a virtual drive mapping component enables an application to run locally on a client while data is accessed remotely.

32. The remote access desktop software application according to claim 12 wherein a servlet monitors the server and dynamically updates the communication string passed between the front end code and the back end code.

33. The remote access desktop software application according to claim 31 wherein the servlet causes an update of the communication string to be seamless as perceived by a user.
